(19) United States
(12) Patent Application Publication
(10) Pub. No.: US 2015/0339279 A1
(43) Pub. Date: Nov. 26, 2015

(54) TYPING ERROR DETECTING DEVICE AND RECORDING MEDIUM

(71) Applicant: I.B.RESEARCH Inc., Kashiwazaki-shi (JP)

(72) Inventor: Masato FUJISAWA, Kashiwazaki-shi (JP)

(73) Assignee: I.B.RESEARCH Inc., Kashiwazaki-shi (JP)

(21) Appl. No.: 14/409,382

(22) PCT Filed: Apr. 17, 2014
(86) PCT No.: PCT/JP2014/060973

§ 371 Date: Dec. 18, 2014

(30) Foreign Application Priority Data
Apr. 17, 2013 (JP) 2013-086783

(51) Int. Cl. G06F 17/24; G06F 17/27; G06F 17/30

(52) U.S. Cl. CPC G06F 17/24; G06F 17/30011; G06F 17/2735

(57) ABSTRACT

A typing error detecting device includes arranging means that lists all words in a document in a designated order in the vertical direction and display means that displays words that have designated similarity (for example, a word which has only one different character) to one word so as to be distinguishable from other words.

### TECHNICAL FIELD

The present invention relates to a typing error detecting device that detects a typing error in a document and a recording medium.

### BACKGROUND ART

PTL 1 discloses a code checking device as a typing error detecting device that detects a typing error in a document.

FIG. 12 is a block diagram of the code checking device in the related art, which is disclosed in PTL 1.

As illustrated in FIG. 12, the code checking device is configured to have a code extracting unit 3, an adjacent character string extracting unit 4, a buffer memory 5, a sorting unit 6, a code designating unit 7, and a character string position selecting unit 8.

The code extracting unit 3 extracts a character string (for example, a number) specified as a code from a document 1 (specification drafted for Japanese patent application) which is a target of a checking process of the code.

FIG. 13 is a view illustrating a structure of the document 1 disclosed in PTL 1. As illustrated in FIG. 13, as character information, the document 1 includes “0018” as a paragraph number, “FIG. 5 is a side view illustrating a joining device according to the present invention.” as a first sentence, and “In the drawing, two plates 10 and 11 are tightly joined to each other by using a bolt 12 and a nut 13.” as a second sentence.

For example, it turns out that the code extracting unit 3 extracted “12” as the code from “bolt 12” from the second sentence. It means that, in the document 1, “12” is a code appended to the word “bolt”. In the case where the code extracting unit 3 extracts the code “12”, the adjacent character string extracting unit 4 extracts a character string including the predetermined number of characters (for example, a character string of 15 characters) which is positioned before “1” from the code “12” as a character string representing a word to which the code “12” is appended.

As illustrated in FIG. 13, “Ni Mai No Ita 1 0 To 1 1 To Ha, Bo Ru To” (total 15 characters) is extracted as the character string including the word to which the code “12” is appended. In a case where the character string is extracted in this way, a code extracting position is registered in association with the character string “Ni Mai No Ita 1 0 To 1 1 To Ha, Bo Ru To” and the code “12”. The code extracting position is determined by a paragraph “18” in which the extracted code is present, the number of sentences of “2” from the beginning of the same paragraph, in which the extracted code is present, and the number of characters of “23” from the beginning of the same sentence, in which the extracted code is present. In a case of extracting the character string including a word to which the code is appended, a record 15 including data is created.

In this way, as illustrated in FIG. 12, in addition to a code and a word to which the code is appended, a character string of the predetermined number or less of characters including the word and a code extracting position are displayed on the display unit 11.

FIG. 14 is a view illustrating the details of a registered record.

When codes are searched for within the document 1 and records 15 are created for each code in order, as illustrated in FIG. 3, records 15 are arranged line by line. Since the order means the extracting order of the code, the word to which the same code is appended is arranged to be scattered. Since it is inconvenient to perform comparison in this way, the word and character strings to which the same code is appended are displayed for each code, as illustrated in FIG. 15, for example.

### CITATION LIST

### Patent Literature

[PTL 1] JP-A-H9-259148

### SUMMARY OF INVENTION

### Technical Problem

The above-described code checking device in the related art is used to extract a code and a character string including the predetermined number of characters present before the code in the document 1 which is a processing target. Therefore, a document such as a specification drafted for the Japanese patent application can be a target of the checking process of the code checking device in the related art, but it is not possible for a document in which no code is included to be the target of the checking process.

Further, since there is a need to simultaneously extract not only a code but also a character string present before the code, the extracting process inevitably becomes complicated in the code checking device in the related art.

The present invention is made as a result of taking into account the problems in such a code checking device in the related art and an object of the invention is to provide a typing error detecting device in which it is possible to easily detect a typing error not only in a document in which a code is used but also a document in which no code is used and a recording medium.

### Solution to Problem

In order to achieve the object, a typing error detecting device according to the present invention has the flowing features (1) to (15).

(1) A typing error detecting device comprises:

a control unit that executes a computing process; and

a display unit that outputs a result obtained through the computing process of the control unit,

wherein the control unit extracts a character string that is specified as a word in accordance with a word extracting rule from a document which is configured to include text data and sorts the extracted character strings in accordance with a rearrangement rule, and

wherein the display unit displays the character strings sorted by the control unit.

(2) In the typing error detecting device according to (1),

the control unit extracts a character string having a series of a predetermined number or more of characters in Kanji, katakana, or English as a word, from the document.

(3) In the typing error detecting device according to (1),

the control unit sorts the character strings such that characters positioned at the beginning of the character strings are arranged in a predetermined order.

(4) In the typing error detecting device according to (2),

in a case where there are at least two character strings having degree of similarity to each other among the character strings extracted by the control unit, the display unit outputs these character strings to be visibly recognized as one group.

(5) In the typing error detecting device according to (4),

the display unit outputs each character string that constitutes the group in a state where characters at the beginning are arranged in a vertical direction in a column or in a state where characters at the end are arranged in the vertical direction in a column.

(6) In the typing error detecting device according to (4),

in a case where there is a plurality of groups, the display unit outputs the groups so as to be distinguishable from each other.

(7) In the typing error detecting device according to (1),

the control unit extracts, as a word, a character string that includes at least two spaces of a space at the beginning and a space at the end and a predetermined number of spaces from the document.

(8) In the typing error detecting device according to (7),

the display unit outputs the character strings in a state in which the characters at the end are arranged in a vertical direction in a column.

(9) The typing error detecting device according to (1), further comprises:

an input unit that receives operation of an operator,

wherein the control unit extracts, as a word, a character string that matches a character string which the input unit receives, from the document.

(10) In the typing error detecting device according to (9),

the control unit further extracts, as a word, another character string that has similarity to the character string which the input unit receives.

(11) In the typing error detecting device according to (10),

the display unit outputs the character string and another character string in a state where characters at the beginning are arranged in a vertical direction in a column or in a state where the characters at the end are arranged in the vertical direction in a column.

(12) In the typing error detecting device according to (1),

the control unit first detects a number from the document, extracts, as a word, a character string positioned before the number by the number of spaces which is designated, and sorts the character strings on the basis of the number corresponding to the extracted character string.

(13) In the typing error detecting device according to (12),

in a case where there are at least two character strings corresponding to the same number among the character strings extracted by the control unit, the display unit outputs these character strings so as to be recognizable as one group.

(14) In the typing error detecting device according to (13),

the display unit outputs each character string that constitutes the group in a state where the characters at the end are arranged in a vertical direction in a column.

(15) In the typing error detecting device according to (13),

in a case where there is a plurality of groups, the display unit outputs the groups so as to be distinguishable from each other.

In order to achieve the object, a recording medium according to the present invention has the flowing feature (16).

(16). A recording medium is written with a program for causing the control unit and the display unit according to any one of (1) to (15) to execute a process.

### Advantageous Effects of Invention

In the typing error detecting device and the recording medium, it is possible to specify a character string that should be extracted as a word even in a document in which no code is used and to display these specified character strings to be gathered in a group (word group). Therefore, an operator views these character strings gathered in groups (word groups), and then can find a typing error in words expressed by the character strings easily and within a very short time through comparing a character string including a typing error to another character string (that is, a character string that is typed correctly).

### BRIEF DESCRIPTION OF THE DRAWINGS

FIG. 1 is a block diagram of a typing error detecting device according to a first embodiment of the present invention.

FIG. 2 is a view illustrating a part of a document stored in a memory in the typing error detecting device according to the first embodiment of the present invention.

FIG. 3 is a view illustrating an example of a list of word groups that are extracted by an arranging means.

FIG. 4 is a view illustrating an example of a word list obtained in a case where character strings are arranged in a state in which characters at the end of the character strings are arranged in the vertical direction.

FIG. 5 is a block diagram of a typing error detecting device according to a second embodiment of the present invention.

FIG. 6 is a view illustrating an example of a word list of the typing error detecting device according to the second embodiment of the present invention.

FIG. 7 is a block diagram of a typing error detecting device according to a third embodiment of the present invention.

FIG. 8 is a view illustrating a part of a document stored in a memory in the typing error detecting device according to the third embodiment of the present invention.

FIG. 9 is a view illustrating an example of a word list word combination groups of the typing error detecting device according to the third embodiment of the present invention.

FIG. 10 is a block diagram illustrating a typing error detecting device according to a modified example of the typing error detecting device according to the third embodiment of the present invention.

FIG. 11 is one example of a block diagram of the typing error detecting device according to the first embodiment.

FIG. 12 is a block diagram of the code checking device in the related art.

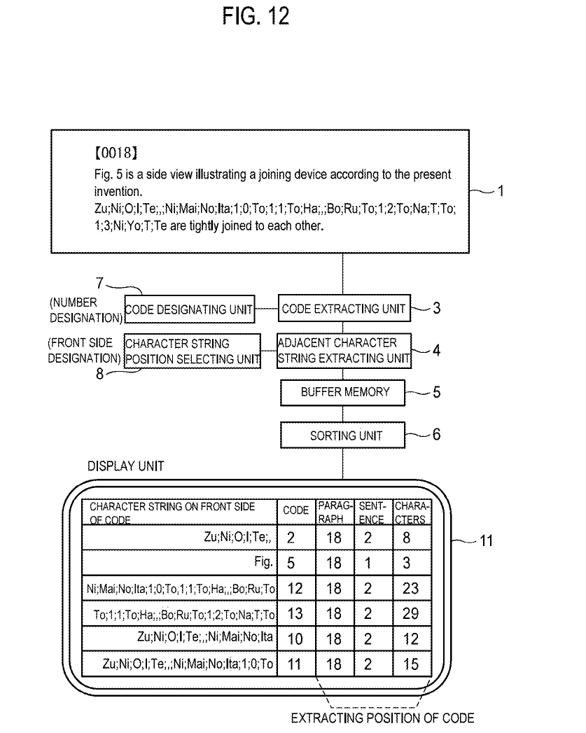

FIG. 13 is a view illustrating a structure of a document as a target of a code checking process by the code checking device in the related art.

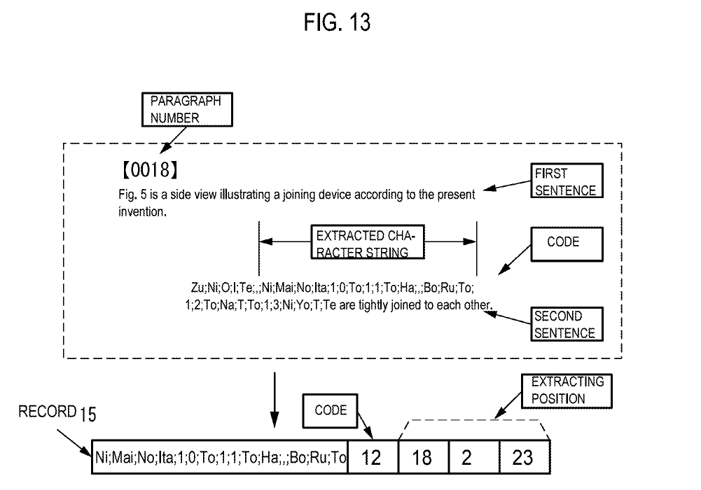

FIG. 14 is a view illustrating details of a registered record by the code checking device in the related art.

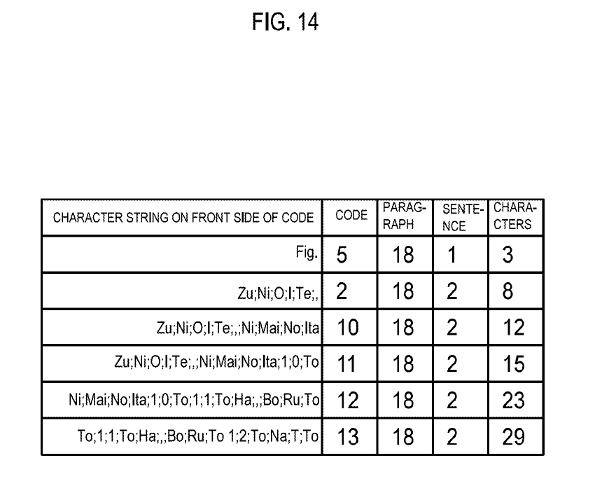

FIG. 15 is a view illustrating details of data extracted by the code checking device in the related art.

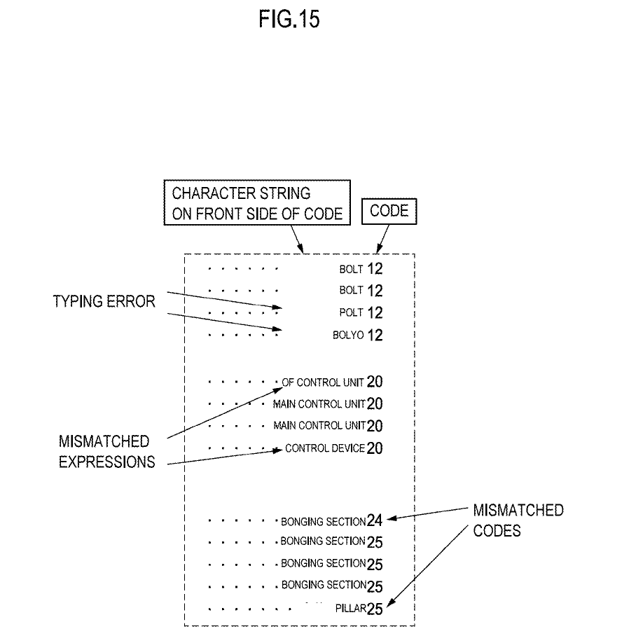

### DESCRIPTION OF EMBODIMENTS

### First Embodiment

First, a typing error detecting device and a typing error detecting method according to the first embodiment of the present invention are described.

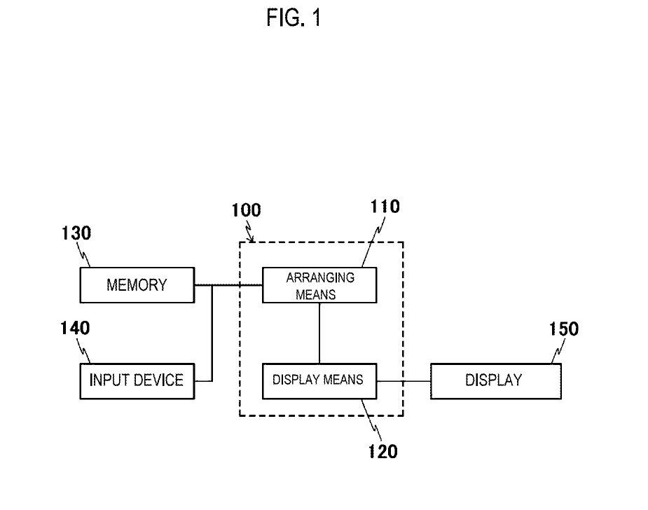

FIG. 1 is a block diagram of a typing error detecting device 100 according to the first embodiment of the present invention. The typing error detecting device 100 can be realized by using a personal computer (PC) including electronic components such as a central processing unit (CPU), a random access memory (RAM), a read only memory (ROM), and a hard disk drive (HDD). The typing error detecting device 100 performs a computing process with reference to software for causing the typing error detecting device 100 to execute the typing error detecting method of the present invention, which is stored in the ROM or the HDD or is expanded on the ROM or the HDD, and executes the typing error detecting method which will be described later. In the course of the execution, a computing result output from the CPU is written in the RAM.

As illustrated in FIG. 1, the typing error detecting device 100 according to the present embodiment includes arranging means 110 and display means 120 as functional units. The arranging means 110 and the display means 120 are collectively referred to as a control unit.

Further, the typing error detecting device 100 is connected to an external memory 130 and an input device 140 as input devices through which information is input into the typing error detecting device 100, and connected to a display 150 as a display device which outputs information from the typing error detecting device 100. The input device 140 is referred to as an input unit in some cases. In addition, the display 150 is referred to as a display unit in some cases.

The arranging means 110 can be considered as a process of a computing function by the CPU. With reference to the software for causing the typing error detecting device 100 to execute the typing error detecting method according to the invention, the arranging means 110 reads electronic data (predetermined document which will be described later) stored in the external memory 130, inputs an operation signal from the input device 140 which receives operation from an operator, and detects a typing error by executing computation in accordance with the software. The specific process of the arranging means 110 will be described later in detail.

The display means 120 can be considered as a process of a computing function of the CPU. With reference to the software for causing the typing error detecting device 100 to execute the typing error detecting method according to the invention, the display means 120 reads the typing error detecting result output from the arranging means 110 and outputs, to the display 150, a control signal for outputting the typing error detecting result in a display form recognizable by the operator. The specific display form to be displayed on the display 150 will be described later in detail.

A document drafted by using word-processing software (for example, Word (registered trademark) by Microsoft Corporation in the U.S.A.) is stored in the form of an electronic file in the external memory 130. According to the embodiment of the present invention, the document is, for example, a specification drafted for Japanese patent application. According to the embodiment of the present invention, the external memory 130 is a recording medium or a recording device that is connectable to the typing error detecting device 100 as a PC. Normally, according to the embodiment of the present invention, the document in the form of an electronic file is input to the typing error detecting device 100 through the external memory 130, but the document in the form of an electronic file may be input to the typing error detecting device 100 through a network instead of the external memory 130. Otherwise, an environment may be provided, in which the word-processing software can be installed into the typing error detecting device 100 and the typing error detecting device 100 itself can draft and retain a document in a form of an electronic file. The bottom line is that the typing error detecting device 100 may have a form in which the document as an electronic file is input thereto or stored therein.

As the input device 140, various input devices which are connectable to a PC can be utilized. The input device 140 is configured to have, for example, a mouse, a keyboard, or the like. In a case where operation of an operator is received by the input device 140, the input device 140 outputs an operation signal to the typing error detecting device 100 in accordance with the received operation.

The display 150 can utilize various display devices. The display 150 is configured to have, for example, a CRT display, a quartz crystal display, an organic EL display, or the like. In a case where a control signal is input from the typing error detecting device 100, the display 150 displays an image on a display screen in accordance with the input control signal.

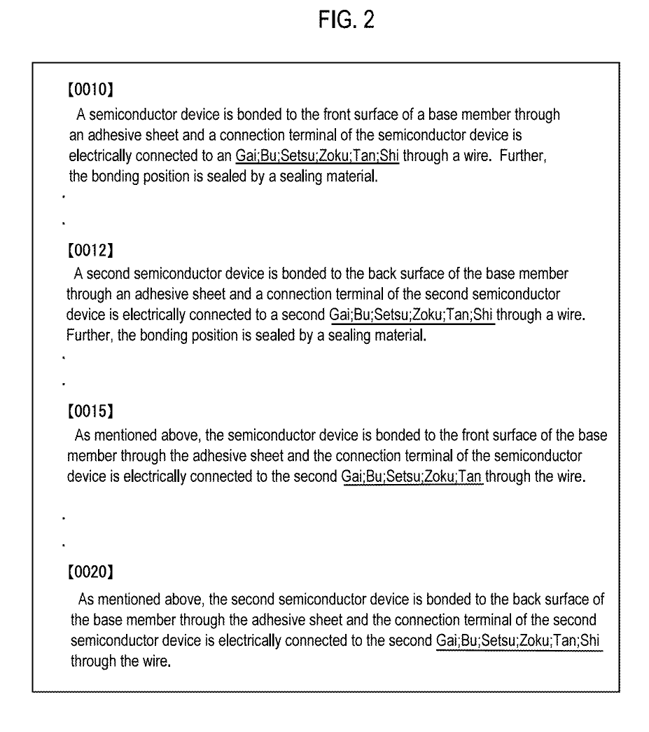

Hereinafter, processes performed by the typing error detecting device 100, that is, the processes performed by the arranging means 110 and the display means 120 are specifically described by using an example of a case where the document stored in the external memory 130 is a specification drafted for the Japanese patent application. First, a structure of the document stored in the external memory 130 is described, before the processes performed by the typing error detecting device 100 are described. FIG. 2 is a view illustrating a part of a document stored in the external memory 130.

The document stored in the external memory 130 is an electronic file that is configured to have text data. This document is a part of the description of the specification in which a paragraph number is assigned for each paragraph (in FIG. 2, [0010], [0012], [0015], and [0020]) as illustrated in FIG. 2. The description of each paragraph is provided with one or a plurality of sentences in which sentences are separated by a period.

Subsequently, operation of the typing error detecting device 100 according to the present embodiment will be described.

First, the operator inputs, to the arranging means 110 through the input device 140, information (hereinafter, referred to as range information) for designating a range within which the typing error detection is performed, a rule (hereinafter, referred to as a word extracting rule) for specifying a character string that is extracted as a word, a rule (hereinafter, referred to as a rearrangement rule) used when the extracted character string as a word is rearranged, and a condition of a character string (hereinafter, referred to as a degree of similarity) that can be considered as representing the same word.

The range information is information for designating a random range in the document. For example, in the case of including types of texts such as an application form, a specification, a claim, or an abstract in the document, one or a plurality of types of texts (for example, the entire specification) among these types is designated as the range information. Otherwise, in the case where a page number is put in the document, specific pages (for example, from page 3 to page 8) among the pages are designated by the range information. In addition, in the case where paragraph numbers are put in the document, specific paragraphs (for example, paragraph number 0005 to paragraph number 0070) among the paragraph numbers are designated as the range information.

In addition, a rule for specifying a character string to be extracted as a word among character strings typed in the document is prescribed by the word extracting rule. Examples of the word extracting rule include extracting, as a word, a character string which has a series of a predetermined number or more of characters in Kanji, extracting, as a word, a character string which has a series of a predetermined number or more characters in Katakana, extracting, as a word, a character string which has a series of a predetermined number or more characters in English alphabet, extracting, as a word, a character string which has a series of a predetermined number or more of characters in Kanji, Katakana, or English, or the like.

In addition, when there is a plurality of character strings extracted as a word and all or a part of the character strings are displayed on the display 150, a rule to display the character strings on the display screen of the display 150 is prescribed by the rearrangement rule. The rearrangement rule includes, for example, rearrangement of the character strings in order of JIS code, order of Japanese characters (order of a, i, u, e, and o), or order of English characters with reference to the character positioned at the beginning of the character string extracted as a word. In addition, the rearrangement rule includes, for example, rearrangement of the character strings in order of JIS code, order of Japanese characters, or order of English characters with reference to the character at the end of the character string extracted as a word.

In addition, the degree of similarity is a condition for specifying at least two character strings which can be considered as representing the same word in a case where there is a plurality of character strings extracted as words. A character string representing a certain word having a typing error and a character string representing the same word not having a typing error have similarity to each other in the characters constituting the character strings. The degree of the similarity represents the extent to which a certain character string is similar to another character string. For example, in a case where “the number of characters 1” is designated, character strings in which the number of different characters is 0 or 1 are all determined as character strings representing the same word.

The degree of the similarity is described further in detail with reference to FIG. 2. For example, in paragraph [0010] of the specification, “Gai;Bu;Setsu;Zoku;Tan;Shi” in Japanese (hereinafter, in order to make it easy for a technical idea of the invention to be understood when the present specification is translated into a foreign language, a series of six characters of Kanji which means the “Gai;Bu;SetsuSetsu;Zoku;Tan;Shi” is written along with six characters of “ABCDEF” in English in parentheses. Here, “Gai” indicates “A”, “Bu” indicates “B”, “Setsu” indicates “C”, “Zoku” indicates “D”, “Tan” indicates “E”, and “Shi” indicates “F”) is typed for the first time and the character string of “Gai;Bu;Setsu;Zoku;Tan;Shi (ABCDEF)” typed in the paragraph [0010] is extracted as a word. Then, when detection of a word is performed in the subsequent paragraphs [0010], [0012], and [0020], character strings in which the number of different characters is 1 or greater compared to the “Gai;Bu;Setsu;Zoku;Tan;Shi (ABCDEF)”, that is, “Gai;Bu;Setsu;Zoku;Tan;Shi (ABCDEF)” (the number of different characters is 0) and “Gai;Bu;Setsu;Zoku;Tan (ABCDE)” (the number of different characters is 1), are all associated with each other as one group representing the “Gai;Bu;Setsu;Zoku;Tan;Shi”. Similarly, for example, even in the case where character strings such as “Gai;Bu;Setsu;Zoku;You;Tan;Shi (ABCDGEF, here “You” indicates “G”)”, “Gai;Bu;Setsu;Zoku;Tan (ABCDE)”, “Gai;Bu;Setsu;Zoku;Tan;Shi;Goon (ABCDEFH), here “Goon” indicates “H”” (the number of different characters is 1 in any one of them) are detected as a word, these character strings are all extracted in a state of being associated with each other as one group representing the “Gai;Bu;Setsu;Zoku;Tan;Shi (ABCDEF)”.

The operation of the typing error detecting device 100 according to the present embodiment is described again. According to the present embodiment, the following range information, word extracting rule, rearrangement rule, and degree of the similarity are input into the arranging means 110.

Range Information=Entire Specification

Word extracting Rule=Character Strings Having a Series of Two or More of Characters of Kanji, Katakana, or English

Rearrangement rule=Order of A, I, U, E, and O of the Characters positioned at the beginning of Character Strings

Degree of the Similarity=To Allow the Number of Different Characters to Be Less Than One

In accordance with these conditions, when the range information and the rearrangement rule are input through the input device 140, the arranging means 110 extracts all of the words included in the designated range, that is, the entire specification, and executes a task of aligning the extracted words in the order of A, I, U, E, and O in the vertical direction.

Specifically, the arranging means 110 searches for a character string that is determined as a word from the first line in text data which forms a specification in accordance with the word extracting rule and, when the character string is detected, registers data obtained in association with the character string and a paragraph number of a paragraph where the character string is typed as one record. After the record is registered, the arranging means 110 searches text data positioned after the character string as a target for a character string that is determined as a word in accordance with the word extracting rule. Then, a process of registering one record is repeatedly performed whenever a character string that is determined as a word is detected. As a result, the records are registered in order of appearance in which the character strings are detected as a word. When reaching the end of the text data that forms the specification, the search for the word in accordance with the word extracting rule is finished.

Subsequently, the display means 120 sorts these records in accordance with the rearrangement rule with reference to the registered records by the process described above. Particularly, the display means 120 sorts the records such that the characters positioned at the beginning of the character strings are arranged in the order of A, I, U, E, and O, with reference to the character string of the registered record. As a result, the aligning order of records is changed from the detected appearance order as words to the order of A, I, U, E, and O of the characters positioned at the beginning of the character string. Normally, in a case where there is a plurality of character strings having the same characters at the beginning, the records including these character strings are aligned in the order of the appearances in which the character strings are detected as the words.

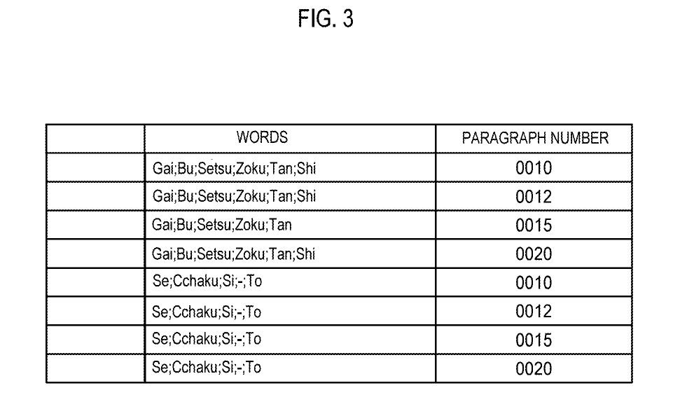

FIG. 3 illustrates an example of a list of word groups that are extracted by the arranging means 110 and arranged by the display means 120.

As illustrated in FIG. 2, in the specification as a typing error detection target, “Gai;Bu;Setsu;Zoku;Tan;Shi (ABCDEF)” is typed in the paragraph [0010], “Gai;Bu;Setsu;Zoku;Tan;Shi (ABCDEF)” is typed in the paragraph [0012], “Gai;Bu;Setsu;Zoku;Tan (ABCDE)” is typed in the paragraph [0015], and “Gai;Bu;Setsu;Zoku;Tan;Shi (ABCDEF)” is typed in the paragraph [0020]. Therefore, the list illustrated in FIG. 3 shows a state in which each word of “Gai;Bu;Setsu;Zoku;Tan;Shi (ABCDEF)”, “Gai;Bu;Setsu;Zoku;Tan;Shi (ABCDEF)”, “Gai;Bu;Setsu;Zoku;Tan (ABCDE)”, and “Gai;Bu;Setsu;Zoku;Tan;Shi (ABCDEF)” is aligned in the vertical direction.

After the arranging means 110 sorts the records in accordance with the rearrangement rule in this way, the display means 120, subsequently, outputs, to the display 150, a control signal for causing the display 150 to display these records. Specifically, the display means 120 aligns the records in the vertical direction and causes the character strings to be displayed on the left side of any record (column of “word” in FIG. 3) and paragraph numbers to be displayed on the right side (column of “paragraph number” in FIG. 3). Further, the character strings displayed on the left side in the records (column of “word” in FIG. 3) is in a state where the characters at the beginning are arranged in the vertical direction, that is, the characters are displayed flush left. Further, the character strings displayed on the right side in the records (column of “paragraph number” in FIG. 3) are displayed centered.

As is clear from FIG. 3, in a state in which words of “Gai;Bu;Setsu;Zoku;Tan;Shi (ABCDEF)”, “Gai;Bu;Setsu;Zoku;Tan;Shi (ABCDEF)”, “Gai;Bu;Setsu;Zoku;Tan (ABCDE)”, and “Gai;Bu;Setsu;Zoku;Tan;Shi (ABCDEF)” are arranged in the vertical direction, an operator can easily find that “Gai;Bu;Setsu;Zoku;Tan (ABCDE)” is a typing error.

Further, the display means 120 causes records including the character strings which are associated with each other as one group to be displayed in the same color and records associated with each group among a plurality of groups to be displayed in a different color. Specifically, for example, a word group having “Gai;Bu;Setsu;Zoku;Tan;Shi (ABCDEF)” that is allowed by the number of characters of 1 which is a designated degree of the similarity is caused to be displayed in a different color from other word groups on the display 150. That is, as illustrated in FIG. 3, the display means 120 causes the word group of “Gai;Bu;Setsu;Zoku;Tan;Shi (ABCDEF)”, “Gai;Bu;Setsu;Zoku;Tan;Shi (ABCDEF)”, “Gai;Bu;Setsu;Zoku;Tan (ABCDE)”, and “Gai;Bu;Setsu;Zoku;Tan;Shi (ABCDEF)” to be displayed in blue and the other word groups (for example, “adhesive sheet”) to be displayed respectively in a color (for example, yellow) other than blue. When the operator views the display 150 on which such a display is performed, the operator can easily distinguish the word groups having the designated degree of the similarity, group by group.

As above, in the typing error detecting device 100 according to the present embodiment, character strings that are to be extracted as words in accordance with the word extracting rule are detected, and records including the detected character strings are registered, and these records are sorted in accordance with the rearrangement rule. Therefore, it is possible to specify a character string that is to be extracted as a word in a document without using the reference codes and it is possible to display these specified character strings gathered into one group (word group). Therefore, the operator views these character strings gathered into one group (word group), compares a character string including a typing error with another character string (that is, correctly typed character string) and thereby can easily find a typing error in a word that is expressed by the character string.

Further, in the typing error detecting device 100 according to the present embodiment, the characters positioned at the beginning of the character strings of the records are displayed in the vertical direction in a state of being arranged, that is, in a state where the character strings of the records are flush left. Therefore, it is possible to find a typing error of missing a character or having an extra character easily and within a very short time.

Normally, the typing error detecting device 100 according to the present embodiment is not limited thereto, and various modifications can be performed thereto.

According to the present embodiment, the specification for Japanese patent application which is written in Japanese is described as an example, but a document written in another language can be a target. For example, a specification in English which is drafted for US patent application can be the target.

In a case where the specification that is drafted for the US patent application is the target, there is a need to use a different word extracting rule from that used in a case where the specification that is drafted for the Japanese patent application is the target. In the case of the specification for the Japanese patent application, a character string which includes a series of a predetermined number or more of characters in Kanji, Katakana, or English is recognized as a word. However, in the case of the specification for US patent application, a character string between a space and a space can be recognized as a word. Therefore, the number of spaces which is allowed in one word is designated and thereby it is possible to extract a character string including a predetermined number of spaces, that is, including at least one of both of one space at the first position and one space at the last position, as one English word. For example, in the case where the operator designates the number of spaces as four, a character string including one space at the first position and one space at the last position and two spaces between the first and last positions, as in “a bbbb cccc” is extracted as one English word.

Such a word extracting rule is caused to correspond to English, a rule of aligning each character string in an alphabetic order is applied as the rearrangement rule, and thereby the present invention can be applied to the specification in English which is drafted for the US patent application as a target.

In addition, according to the present embodiment, the extracted character strings as the words are gathered into and displayed as one group (word group) by using the degree of the similarity. The character strings can be gathered into and displayed as one group (word group) by using a factor other than the number of characters as the degree of the similarity. For example, as the degree of the similarity, 20% or less of a difference in the number of characters with respect to the number of characters of one character string can be set. In this case, when a certain character string includes eight characters, 20% of eight characters become 1.6 characters. Therefore, it is possible to round up the figure and obtain 2 characters (corresponding to the number of characters 2) or to round down and obtain one character (corresponding to the number of characters of 1).

In addition, in the typing error detecting device 100 according to the present embodiment, the display means 120 distinguishes the word groups from each other by changing colors, but may employ another method. For example, instead of the change of colors or along with the change of colors, change of the size, the font, or the like of one word group makes it possible to distinguish the word group from other word groups.

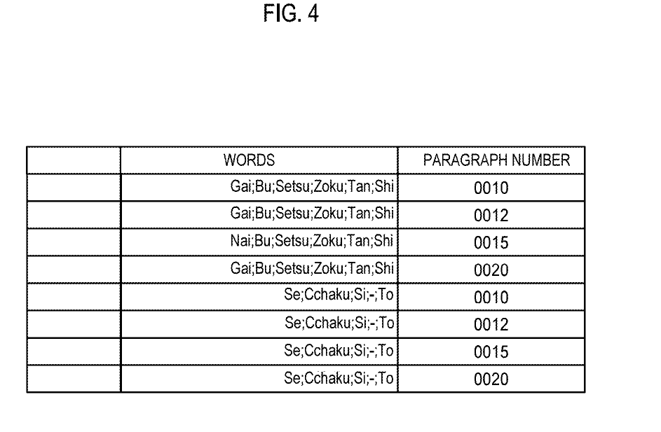

In addition, in the typing error detecting device 100 according to the present embodiment, the arranging means 110 arranges the character strings in a state where the characters positioned at the beginning of the character strings are arranged in the vertical direction (that is, flush left), but may arrange the character strings in a state where the characters at the end of the character strings are arranged in the vertical direction (that is, flush right). FIG. 4 illustrates an example of a word list obtained in a case where the character strings are arranged in a state in which the characters at the end of the character strings are arranged in the vertical direction.

In a case where the character strings are arranged in a state where the characters positioned at the beginning of the character strings are arranged in the vertical direction (flush left) (refer to FIG. 3), a character string which includes a typing error in the character at the beginning is not associated with a word group to which the character string should be included normally. For example, in a case where instead of “Gai;Bu;Setsu;Zoku;Tan;Shi (ABCDEF)”, “Nai;Bu;Setsu;Zoku;Tan;ShiSetsu (IBCDEF), here “Nai” indicates “I”” is typed mistakenly, and “Nai;Bu;Setsu;Zoku;Tan;Shi (IBCDEF)” is associated with the group of “Na in Japanese (first consonant when “I” is pronounced)”. Therefore, “Nai;Bu;Setsu;Zoku;Tan;Shi (IBCDEF)” is not included in a word group of “Gai;Bu;Setsu;Zoku;Tan;Shi (ABCDEF)” (a group of character strings having the degree of the similarity designated with respect to “Gai;Bu;Setsu;Zoku;Tan;Shi (ABCDEF)”) which is extracted as the group of “Ka in Japanese (first consonant when “A” is pronounced)”. Accordingly when only the word group of “Gai;Bu;Setsu;Zoku;Tan;Shi (ABCDEF)” is viewed, it is not possible to find “Nai;Bu;Setsu;Zoku;Tan;Shi (IBCDEF)” as a typing error.

In order to address such a problem, it is possible to arrange the character strings in a state in which the arranging means 110 arranges the characters at the end of the character strings in the vertical direction. Through such arranging, as illustrated in FIG. 4, it is possible to include “Nai;Bu;Setsu;Zoku;Tan;Shi (IBCDEF)” in the word group of “Gai;Bu;Setsu;Zoku;Tan;Shi (ABCDEF)”. Therefore, it is possible to find “Nai;Bu;Setsu;Zoku;Tan;Shi (IBCDEF)” as a typing error.

### Second Embodiment

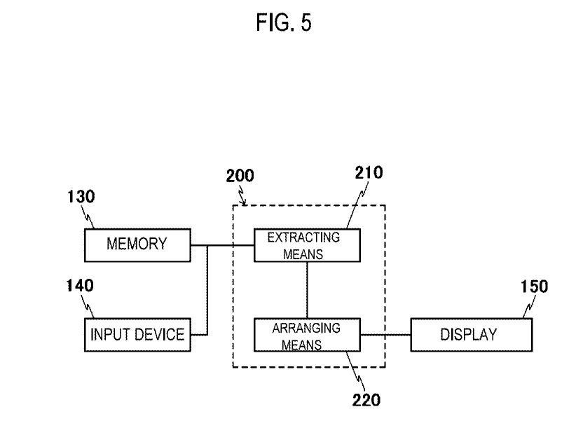

Next, a typing error detecting device and a typing error detecting method according to a second embodiment of the present invention are described. FIG. 5 is a block diagram of a typing error detecting device 200 according to the second embodiment of the present invention. Similar to the typing error detecting device 100 according to the first embodiment, the typing error detecting device 200 can be realized by using a personal computer (PC) including electronic components such as a central processing unit (CPU), a random access memory (RAM), a read only memory (ROM), and a hard disk drive (HDD). The typing error detecting device 200 performs a computing process with reference to software for causing the typing error detecting device 200 to execute the typing error detecting method of the present invention, which is stored in the ROM or the HDD or is expanded on the ROM or the HDD, and executes the typing error detecting method which will be described later. In the course of the execution, a computed result output from the CPU is written in the RAM.

As illustrated in FIG. 5, the typing error detecting device 200 according to the present embodiment includes extracting means 210 and arranging means 220 as functional units. The extracting means 210 and the arranging means 220 are collectively referred to as a control unit.

Further, the typing error detecting device 200 is connected to the external memory 130 and the input device 140 as the input devices through which information is input into the typing error detecting device 200, and connected to the display 150 as the display device which outputs information from the typing error detecting device 200.

The extracting means 210 can be considered as a process of a computing function of the CPU. With reference to the software for causing the typing error detecting device 200 to execute the typing error detecting method according to the invention, the extracting means 210 reads electronic data (predetermined document) stored in the external memory 130, inputs an operation signal from the input device 140 which receives operation from an operator, and detects a typing error by executing computation in accordance with the software. The specific process of the arranging means 210 will be described later in detail.

The arranging means 220 can be considered as a process of a computing function of the CPU. With reference to the software for causing the typing error detecting device 200 to execute the typing error detecting method according to the invention, the arranging means 220 reads the typing error detecting result output from the extracting means 210 and outputs, to the display 150, a control signal for outputting the typing error detecting result in a display form recognizable by the operator. The specific display form to be displayed on the display 150 will be described later in detail.

Similar to the case of the first embodiment, for example, a document drafted for the Japanese patent application is stored in the form of an electronic file in the external memory 130.

Similar to the case of the first embodiment, as the input device 140, various input devices which are connectable to a PC can be utilized. In a case where operation of an operator is received by the input device 140, the input device 140 outputs an operation signal to the typing error detecting device 200 in accordance with the received operation.

Similar to the case of the first embodiment, the display 150 can utilize various display devices. In a case where a control signal is input from the typing error detecting device 200, the display 150 displays an image on a display screen in accordance with the input control signal.

Hereinafter, processes performed by the typing error detecting device 200, that is, the processes performed by the extracting means 210 and the arranging means 220 are specifically described by using an example of a case where the document stored in the external memory 130 is a specification drafted for the Japanese patent application. Since the structure of the document stored in the external memory 130 is as described in the first embodiment, the description is not repeated.

First, the operator inputs, to the extracting means 210 through the input device 140, information designating a range (hereinafter, referred to as range information) for designating a range within which the typing error detection is performed, a character string (hereinafter, referred to as a typing error detecting target word) that is to be extracted as a word, and a condition of a character string (hereinafter, referred to as a degree of similarity) that can be considered as representing the same word.

The range information is information for designating a random range in the document. Since the range information is the same information as that described in the first embodiment, the description is not repeated.

The typing error detecting target word is a character string that is input by an operator. The operator inputs a character string that indicates a word in a case of not including a typing error in the word as the typing error detecting target word.

In addition, the degree of the similarity is a condition for specifying at least two character strings which can be considered as representing the same word in a case where there is a plurality of character strings extracted as words. Since the degree of the similarity is the same information as described in the first embodiment, the description is not repeated.

The operation of the typing error detecting device 200 according to the present embodiment is described again. According to the present embodiment, for example, the following range information, typing error detecting target word, and degree of the similarity are input to the extracting means 210.

Range Information=Entire Specification

Typing Error Detecting Target Word=Gai;Bu;Setsu;Zoku;Tan;Shi (ABCDEF)

Degree of the Similarity=To Allow the Number of Different Characters to Be Less Than One

In accordance with these conditions, when the range information, the typing error detecting target word, and the degree of the similarity are input through the input device 140, the extracting means 210 executes a task of extracting a character string that matches the typing error detecting target word of “Gai;Bu;Setsu;Zoku;Tan;Shi (ABCDEF)” included in the designated range, that is, the entire specification, and a character string that is considered the same word as the typing error detecting target word of “Gai;Bu;Setsu;Zoku;Tan;Shi (ABCDEF)” by the degree of the similarity.

Specifically, the extracting means 210 searches for a character string that matches the typing error detecting target word of “Gai;Bu;Setsu;Zoku;Tan;Shi (ABCDEF)” in the first line of the text data which forms the specification or a character string that is considered as the same word as the typing error detecting target word of “Gai;Bu;Setsu;Zoku;Tan;Shi (ABCDEF)” and, when the character string is detected, registers the character string and a paragraph number of a paragraph where the character string is typed, in accordance with each other as one record. After the one record is registered, the extracting means 210 searches text data positioned after the character string as a target for a character string that matches the typing error detecting target word of “Gai;Bu;Setsu;Zoku;Tan;Shi (ABCDEF)” or a character string that is considered as the same word as the typing error detecting target word of “Gai;Bu;Setsu;Zoku;Tan;Shi (ABCDEF)”. Then, a process of registering one record is repeatedly performed whenever a character string that matches the typing error detecting target word of “Gai;Bu;Setsu;Zoku;Tan;Shi (ABCDEF)” or a character string that is considered as the same word as the typing error detecting target word of “Gai;Bu;Setsu;Zoku;Tan;Shi (ABCDEF)” is detected. As a result, the records are registered in order of appearances in which a character string is detected, which matches the typing error detecting target word of “Gai;Bu;Setsu;Zoku;Tan;Shi (ABCDEF)” or a character string that is considered as the same word as the typing error detecting target word of “Gai;Bu;Setsu;Zoku;Tan;Shi (ABCDEF)”. When reaching the end of the text data that forms the specification, the search for the words is finished.

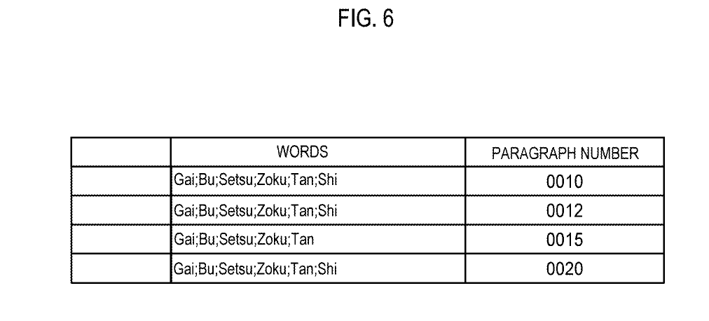

After the extracting means 210 registers the records in this way, the arranging means 220, subsequently, outputs, to the display 150, a control signal for causing the display 150 to display these records. Specifically, the arranging means 220 aligns the records in the vertical direction and causes the character string to be displayed on the left side of any record (column of “word” in FIG. 6) and a paragraph number to be displayed on the right side (column of “paragraph number” in FIG. 6). Further, the character strings displayed on the left side in the records (column of “word” in FIG. 6) are in a state where the characters at the beginning are arranged in the vertical direction, that is, the characters are displayed flush left. Further, the character strings displayed on the right side in the records (column of “paragraph number” in FIG. 6) are displayed centered.

FIG. 6 is a view illustrating an example of a word list which is extracted by the extracting means 210 in this way and arranged by the arranging means 220.

As is clear from FIG. 6, in a state in which words of “Gai;Bu;Setsu;Zoku;Tan;Shi (ABCDEF)”, “Gai;Bu;Setsu;Zoku;Tan;Shi (ABCDEF)”, “Gai;Bu;Setsu;Zoku;Tan (ABCDE)”, and “Gai;Bu;Setsu;Zoku;Tan;Shi (ABCDEF)” are arranged in the vertical direction, an operator can easily find that “Gai;Bu;Setsu;Zoku;Tan (ABCDE)” is a typing error.

As is clear by comparing FIG. 3 and FIG. 6, in the typing error detecting device 100 according to the first embodiment, all the character strings included in the entire specification are displayed in the order of A, I, U, E, and O. Meanwhile in the typing error detecting device 200 according to the second embodiment, only the word group of the designated typing error detecting target word is displayed. Therefore, similar to the typing error detecting device 100 according to the first embodiment, in the typing error detecting device 200 according to the second embodiment, it is possible to specify a character string to be extracted as a word in a document without using the reference codes and it is possible to display these specified character strings gathered into one group (word group). Therefore, the operator views these character strings gathered into one group (word group), compares a character string including a typing error with another character string (that is, correctly typed character string) and thereby can easily find out a typing error in a word that is expressed by the character string.

Further, in the typing error detecting device 200 according to the second embodiment, the characters positioned at the beginning of the character strings of the records are displayed in the vertical direction in a state of being arranged, that is, in a state where the character strings of the records are flush left. Therefore, it is possible to find a typing error of missing a character or having an extra character easily and within a very short time.

In particular, in the typing error detecting device 200 according to the second embodiment, the operator inputs a typing error detecting target word and thereby can perform a typing error detecting process with respect to opening area specific word. Therefore, in a case where the operator desires to search for a typing error with respect to only the specified word, it is possible to reduce the computing load according to the typing error detecting process.

### Third Embodiment

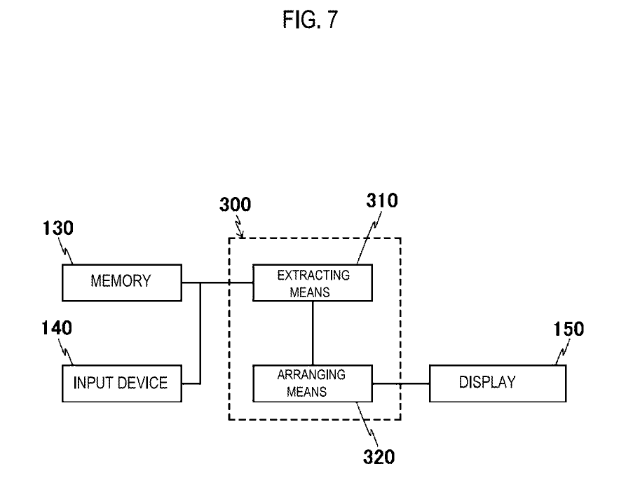

Next, a typing error detecting device and a typing error detecting method according to a second embodiment of the present invention are described. FIG. 7 is a block diagram of a typing error detecting device 300 according to the third embodiment of the present invention. Similar to the typing error detecting device 100 according to the first embodiment, the typing error detecting device 300 can be realized by using a personal computer (PC) including electronic components such as a central processing unit (CPU), a random access memory (RAM), a read only memory (ROM), and a hard disk drive (HDD). The typing error detecting device 300 performs a computing process with reference to software for causing the typing error detecting device 300 to execute the typing error detecting method of the present invention, which is stored in the ROM or the HDD or is expanded on the ROM or the HDD, and executes the typing error detecting method which will be described later. In the course of the execution, a computing result output from the CPU is written in the RAM.

As illustrated in FIG. 7, the typing error detecting device 300 according to the present embodiment includes extracting means 310 and arranging means 320 as functional units. The extracting means 310 and the arranging means 320 are collectively referred to as a control unit.

Further, the typing error detecting device 300 is connected to the external memory 130 and the input device 140 as the input devices through which information is input into the typing error detecting device 300, and is connected to the display 150 as the display device which outputs information from the typing error detecting device 300.

The extracting means 310 can be considered as a process of a computing function of the CPU. With reference to the software for causing the typing error detecting device 300 to execute the typing error detecting method according to the invention, the extracting means 310 reads electronic data (predetermined document) stored in the external memory 130, inputs an operation signal from the input device 140 which receives operation from an operator, and detects a typing error by executing computation in accordance with the software. The specific process of the extracting means 310 will be described later in detail.

The arranging means 320 can be considered as a process of a computing function of the CPU. With reference to the software for causing the typing error detecting device 300 to execute the typing error detecting method according to the invention, the arranging means 320 reads the typing error detecting result output from the extracting means 310 and outputs, to the display 150, a control signal for outputting the typing error detecting result in a display form recognizable by the operator. The specific display form to be displayed on the display 150 will be described later in detail.

A predetermined document drafted by using predetermined word-processing software (for example, Word (registered trademark) of Microsoft Corporation in the U.S.A.) such as a specification drafted for the US patent application is stored in the form of a document in the external memory 130.

Similar to the case of the first embodiment, as the input device 140, various input devices which are connectable to a PC can be utilized. In a case where operation of an operator is received by the input device 140, the input device 140 outputs an operation signal to the typing error detecting device 300 in accordance with the received operation.

Similar to the case of the first embodiment, the display 150 can utilize various display devices. In the case where a control signal is input from the typing error detecting device 300, the display 150 displays an image on a display screen in accordance with the input control signal.

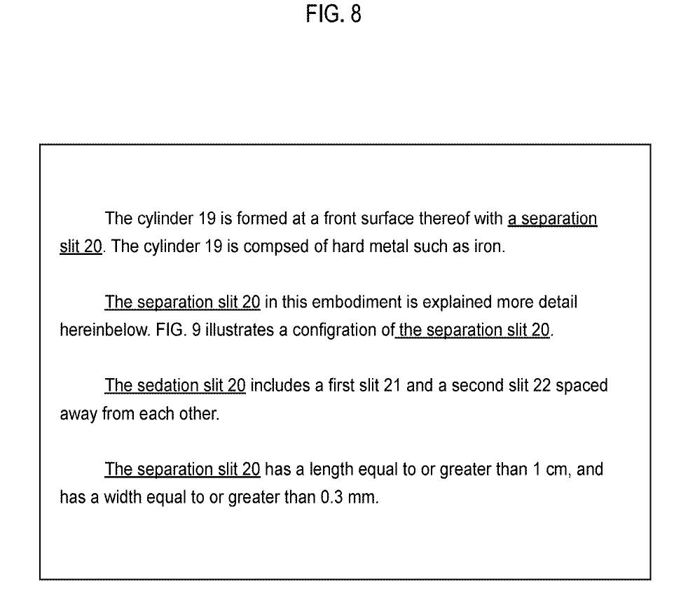

Hereinafter, processes performed by the typing error detecting device 300, that is, the processes performed by the extracting means 310 and the arranging means 320 are specifically described by using an example of a case where the document stored in the external memory 130 is a specification drafted for the US patent application. First, a structure of the document stored in the external memory 130 is described, before the processes performed by the typing error detecting device 300 are described. FIG. 8 is a view illustrating a part of a specification for the US patent application which is stored in the external memory 130.

The document stored in the external memory 130 is an electronic file that is configured to have text data. The same document is a part of the description of the specification which is divided into a plurality of new paragraphs as illustrated in FIG. 8. The description of each paragraph is provided with one or a plurality of sentences in which one sentence is separated by a period.

Subsequently, operation of the typing error detecting device 300 according to the present embodiment will be described.

First, the operator inputs, into the extracting means 310 through the input device 140, information (hereinafter, referred to as range information) for designating a range within which the typing error detection is performed and a rule (hereinafter, referred to as a word extracting rule) for specifying a character string that is extracted as a word.

The range information is information for designating a random range in the document. Since the range information is the same information as that described in the first embodiment, the description is not repeated.

In addition, a rule for specifying a character string to be extracted as a word among character strings typed in the document is prescribed by the word extracting rule. As the word extracting rule, in the case of the specification for Japanese patent application, a character string which has a series of a predetermined number or more of characters in Kanji, Katakana, or English is recognized as a word, but in the case of the specification for the US patent application, a character string between a space and a space can be recognized as a word. Therefore, the number of spaces which is allowed in one word is designated and thereby it is possible to extract one English word. For example, in a case where the operator designates the number of spaces as four, a character string including one space at the first position and one space at the last position and two spaces between the first and last positions, as in “a bbbb cccc” is extracted as one English word. In this case, a word that is constituted by combining three words is extracted.

Further, according to the present embodiment, a character string that is positioned from a number (that is, reference code) as a starting point to a position separated by the designated number of spaces before the number is extracted as one English word. The character string is extracted with the number as a starting point and thereby it is possible to specify a noun in English with higher accuracy.

The operation of the typing error detecting device 300 according to the present embodiment is described again. According to the present embodiment, for example, the following range information and word extracting rule are input to the extracting means 310.

Range Information=Entire Specification

Word Extracting Rule=Character String Positioning Before Number and Including “Four” Spaces

In accordance with these conditions, when the range information and the sorting rule are input through the input device 140, the extracting means 310 extracts all of the character strings that are constituted with three words positioned immediately before a reference code among character strings included in the designated range, that is, the entire specification.

Specifically, the extracting means 310 searches for a character string that is determined as the reference code from the first line of the text data which forms the specification and, when the character string is detected, extracts the character string that is constituted with three words positioned immediately before a reference code. Then, the extracting means 310 registers a character string in which the character string determined as the reference code is added to the character string constituted with three words positioned immediately before the reference code as one record. After the one record is registered, the extracting means 310 searches text data positioned after the character string determined as the reference code as a target for a character string that is determined as the reference code. Then, a process of registering one record is repeatedly performed whenever a character string that is constituted with three words determined as a word is detected. As a result, the records are registered in order of appearance when the character string is detected as a word. When reaching the end of the text data that forms the specification, the search for the words in accordance with the word extracting rule is finished.

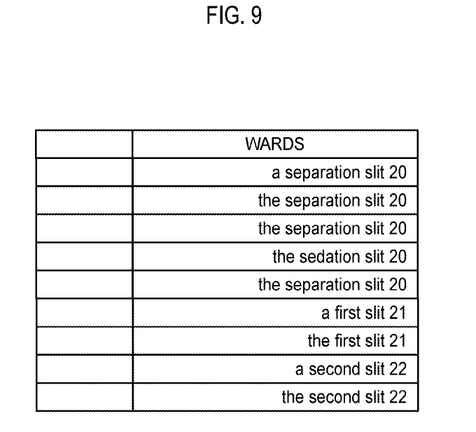

After the extracting means 310 registers the records in this way, the arranging means 220, subsequently, outputs, to the display 150, a control signal for causing the display 150 to display these records. Specifically, the arranging means 320 aligns the records in the vertical direction (column of “WORDS” in FIG. 9). Further, the character strings displayed in the records are in a state where the characters at the end are arranged in the vertical direction, that is, the characters are displayed flush right.

FIG. 9 is a view illustrating an example of a word list which is extracted by the extracting means 310 in this way and arranged by the arranging means 320.

As illustrated in FIG. 9, for example, when a reference code 20 is focused on, the reference code 20 and three words immediately before the reference code are aligned and displayed in the vertical direction such that “20” is arranged in the vertical direction (that is, a state of being flush right). As illustrated in FIG. 8, in the specification drafted for the US patent application, combinations of words having the reference code 20 include “a separation slit 20”, “the separation slit 20”, “the separation slit 20”, “the sedation slit 20”, and “the separation slit 20”. Therefore, in a list illustrated in FIG. 9, these combinations are written in the order of appearance in which the combinations are detected as a word.

As is clear from FIG. 9, in a state in which words of “a separation slit 20”, “the separation slit 20”, “the separation slit 20”, “the sedation slit 20”, and “the separation slit 20” are arranged in the vertical direction (that is, state of being flush right), an operator can easily find that “the sedation slit 20” is a typing error when viewing the head positions of the character strings.

As above, in the typing error detecting device 300 according to the present embodiment, a character string that is positioned from a number (that is, reference code) as a starting point to a position separated by the designated number of spaces before the number is extracted as one English word. Therefore, it is possible to specify a word in English with higher accuracy.

In addition, in the typing error detecting device 300 according to the present embodiment, the reference code and a predetermined number of words immediately before the number are displayed in a state in which the reference codes are arranged in the vertical direction (that is, state in which the character strings in the records are flush right). Therefore, when there is a character string including a typing error among a plurality of records (hereinafter, referred to as a word group) assigned with the same reference code, the character string including the typing error is compared to other character strings (that is, correctly typed character strings) and thereby it is possible to find the typing error easily and within a very short time.

The typing error detecting device 300 according to the present embodiment is not limited to the above-described structure, and various modifications can be performed thereto.

For example, it is possible to input a reference code designated by an operator through the input device 140 to the extracting means 310. In this case, when “20” is input to the extracting means 310 as a reference code, the extracting means 310 extracts a predetermined number of words (for example, three), immediately before “20” as a word. In this case, among the combined word groups illustrated in FIG. 9, only the word group of “a separation slit 20”, “the separation slit 20”, “the separation slit 20”, “the sedation slit 20”, and “the separation slit 20” is displayed on the display 150. In this way, not only all of the reference codes included in an entire specification but also a random reference code is designated and thereby it is possible to perform typing error detection of only one reference code. Therefore, in a case where only the words assigned with a specific reference code are intended to be checked for a typing error, it is possible to reduce the computing load according to the typing error detection process.

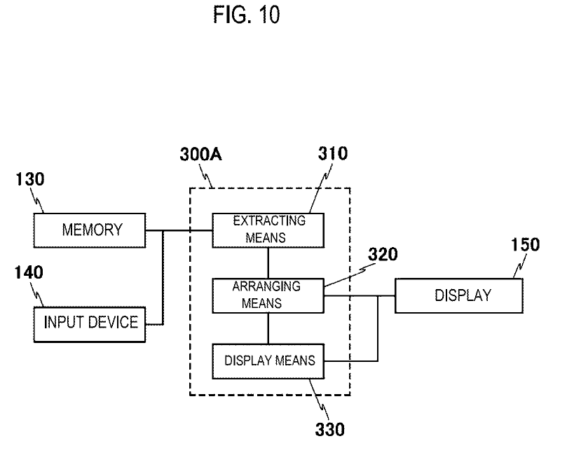

In addition, the typing error detecting device 300 according to the present embodiment may be modified as follows. FIG. 10 is a block diagram illustrating a typing error detecting device 300A according to a modified example of the typing error detecting device 300 according to the present embodiment.

The typing error detecting device 300A according to the present modified example further includes display means 330, compared to the typing error detecting device 300 according to the third embodiment.

The display means 330 can be considered as a process of a computing function of the CPU. With reference to the software for causing the typing error detecting device 300A to execute the typing error detecting method according to the invention, the display means 330 reads the typing error detecting result output from the arranging means 320 and outputs, to the display 150, a control signal for outputting the typing error detecting result in a display form recognizable by the operator. In particular, the display means 330 displays, on the display 150, a word group having the same reference code distinguishable from other word groups.

For example, the display means 330 displays the word group having the same reference code in a different color from the other word group and thereby it is possible for the word group having the same reference code to be easily distinguishable from the other word groups.

For example, with reference to the list illustrated in FIG. 9, the word group of “a separation slit 20”, “the separation slit 20”, “the separation slit 20”, “the sedation slit 20”, and “the separation slit 20” is displayed in blue and a word group of “a first slit 21” and “the first slit 21” is displayed in yellow on the display 150. Accordingly, it is possible to easily distinguish each combined group.

Instead of the change of colors or along with the change of colors, the display means 330 performs change of the size, the font, or the like of a combined group, and thereby it is possible to distinguish the combined group from other combined groups.

(Supplement of a Structure of the Typing Error Detecting Device According to the First to Third Embodiments)

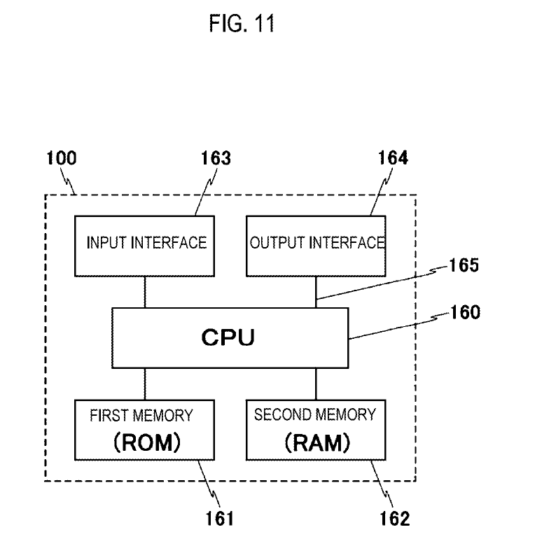

The functions of the typing error detecting devices 100 to 300 according to the first to third embodiments above described can be realized by a program, which is described in detail with reference to FIG. 11.

FIG. 11 is an example of a block diagram of the typing error detecting device 100 according to the first embodiment.

The typing error detecting device 100 is configured to have a central processing unit (CPU) 160, a first memory 161, a second memory 162, an input interface 163 for inputting various instructions and data to the central processing unit 160, an output interface 164 that outputs a result of a process executed by the central processing unit 160, and a bus 165 that connects the central processing unit 160 to other components.

Each of the first and second memories 161 and 162 is configured to have a read only memory (ROM), a semiconductor memory device such as a random access memory (RAM) or an IC memory card, a recording medium such as a flexible disk, a hard disk, or an optical magnetic disk. In the example illustrated in FIG. 11, the first memory 161 is configured to have the ROM and the second memory 162 is configured to have the RAM.

The first memory 161 retains various controlling programs to be executed by the central processing unit 160 and other fixed data. The second memory 162 stores various items of data and parameters and provides an operation region for the central processing unit 160, that is, retains data that is temporarily required after the central processing unit 160 executes the program. The central processing unit 160 reads the program from the first memory 161 and executes the program. That is, the central processing unit 160 operates in accordance with the program stored in the first memory 161.

The typing error detecting device 100 is configured as above, and thereby it is possible to realize the function of the typing error detecting device 100 with the program. The typing error detecting devices 200 and 300 are the same as the typing error detecting device 100.

The present invention is described in detail or with reference to a specific embodiment, but it is obvious for those skilled in the art that various changes or modifications can be applied to the invention without departing from the spirit and range of the invention.

This application is based upon Japanese Patent Application (No. 2013-086783), filed Apr. 17, 2013; the entire content of which is incorporated herein by reference.

### INDUSTRIAL APPLICABILITY

In the typing error detecting device according to the present invention, when there is a typing error in a word group, the word including the typing error is compared to other words (that is, correctly typed words) and thereby it is possible to find the typing error easily and within a very short time. The present invention that achieves this effect is useful in the field related to the typing error detecting device and method in which detection of a typing error in a designated document is easily performed.

### REFERENCE SIGNS LIST

100 typing error detecting device according to the first embodiment of the invention
110 arranging means
120 display means
200 typing error detecting device according to the second embodiment of the invention
210 extracting means arranging means
220 arranging means
300 typing error detecting device according to the third embodiment of the invention
310 extracting means
320 arranging means
330 display means

1. A typing error detecting device comprising:
a control unit that executes a computing process; and
a display unit that outputs a result obtained through the computing process of the control unit,
wherein the control unit extracts a character string that is specified as a word in accordance with a word extracting rule from a document which is configured to include text data and sorts the extracted character strings in accordance with a rearrangement rule, and
wherein the display unit displays the character strings sorted by the control unit.

2. The typing error detecting device according to claim 1,
wherein the control unit extracts a character string having a series of a predetermined number or more of characters in Kanji, katakana, or English as a word, from the document.

3. The typing error detecting device according to claim 1,
wherein the control unit sorts the character strings such that characters positioned at the beginning of the character strings are arranged in a predetermined order.

4. The typing error detecting device according to claim 2,
wherein, in a case where there are at least two character strings having degree of similarity to each other among the character strings extracted by the control unit, the display unit outputs these character strings to be visibly recognized as one group.

5. The typing error detecting device according to claim 4,
wherein the display unit outputs each character string that constitutes the group in a state where characters at the beginning are arranged in a vertical direction in a column or in a state where characters at the end are arranged in the vertical direction in a column.

6. The typing error detecting device according to claim 4,
wherein, in a case where there is a plurality of groups, the display unit outputs the groups so as to be distinguishable from each other.

7. The typing error detecting device according to claim 1,
wherein the control unit extracts, as a word, a character string that includes at least two spaces of a space at the beginning and a space at the end and a predetermined number of spaces from the document.

8. The typing error detecting device according to claim 7,
wherein the display unit outputs the character strings in a state in which the characters at the end are arranged in a vertical direction in a column.

9. The typing error detecting device according to claim 1, further comprising:
an input unit that receives operation of an operator,
wherein the control unit extracts, as a word, a character string that matches a character string which the input unit receives, from the document.

10. The typing error detecting device according to claim 9,
wherein the control unit further extracts, as a word, another character string that has similarity to the character string which the input unit receives.

11. The typing error detecting device according to claim 10,
wherein the display unit outputs the character string and another character string in a state where characters at the beginning are arranged in a vertical direction in a column or in a state where the characters at the end are arranged in the vertical direction in a column.

12. The typing error detecting device according to claim 1,
wherein the control unit first detects a number from the document, extracts, as a word, a character string positioned before the number by the number of spaces which is designated, and sorts the character strings on the basis of the number corresponding to the extracted character string.

13. The typing error detecting device according to claim 12,
wherein, in a case where there are at least two character strings corresponding to the same number among the character strings extracted by the control unit, the display unit outputs these character strings so as to be recognizable as one group.

14. The typing error detecting device according to claim 13,
wherein the display unit outputs each character string that constitutes the group in a state where the characters at the end are arranged in a vertical direction in a column.

15. The typing error detecting device according to claim 13,
wherein, in a case where there is a plurality of groups, the display unit outputs the groups so as to be distinguishable from each other.

16. A recording medium which is written with a program for causing the control unit and the display unit according to claim 1 to execute a process.
